(19) United States
(12) Patent Application Publication
(10) Pub. No.: US 2019/0199743 A1
(43) Pub. Date: Jun. 27, 2019

(54) METHOD AND DEVICE FOR RECOGNIZING ANOMALIES IN A DATA STREAM OF A COMMUNICATION NETWORK

(71) Applicant: Robert Bosch GmbH, Stuttgart (DE)

(72) Inventors: Antonio La Marca, Leonberg (DE); Markus Hanselmann, Stuttgart (DE); Thilo Strauss, Ludwigsburg (DE)

(21) Appl. No.: 16/213,649

(22) Filed: Dec. 7, 2018

(30) Foreign Application Priority Data
Dec. 22, 2017 (DE) 102017223751.1

(51) Int. Cl. H04L 29/06; H04L 12/24; H04L 12/26

(52) U.S. Cl. CPC H04L 63/1425; H04L 63/1416; H04L 43/04; H04L 41/16

(57) ABSTRACT

A method for the automatic recognition of anomalies in a data stream in a communication network. The method includes providing a trained variational autoencoder that is trained on non-faulty data packets, with specification of a reference distribution of latent quantities, indicated by reference distribution parameters; determining one or more distribution parameters as a function of an input quantity vector applied to the trained variational autoencoder, which vector is determined by one or more data packets; and recognizing the one or more data packets as anomalous data packet(s) as a function of the one or more distribution parameters.

### CROSS REFERENCE

The present application claims the benefit under 35 U.S.C. § 119 of German Patent No. DE 102017223751.1 filed on Dec. 22, 2017, which is expressly incorporated herein by reference in its entirety.

### FIELD

The present invention relates to anomaly recognition methods for recognizing errors in data streams or manipulations of data streams. In particular, the present invention relates to methods for recognizing anomalies using machine learning methods.

### BACKGROUND INFORMATION

In communication networks, data are standardly transmitted in packets. Thus, the data transmission via communication networks in motor vehicles can take place using a serial field bus or an Ethernet-based communication network. Examples include the CAN

(Controller Area Network) bus, or the automotive Ethernet, which are predominantly used in motor vehicles. Communication in a CAN network, as well as in other packet-based networks, standardly takes place in the form of successive data packets each identified by an identifier and each having a data segment containing the useful data assigned to the identifier.

In the area of intrusion detection systems (IDS), various methods exist in the automotive field for recognizing anomalies in communication via communication networks. Such anomalies may relate to data packets that contain faulty data, e.g., due to faulty network components, or manipulated data, e.g. due to the injection of data packets from an external source. It is highly important to recognize such anomalies, above all with regard to undesired penetration and manipulation of a system from the outside.

A conventional possibility for recognizing anomalies in data streams is to check each of the transmitted data packets on the basis of rules, i.e., in rule-based fashion. Here, a list of queries, checks, and inferences is created on the basis of which the anomaly recognition method recognizes faulty or manipulated data packets, so-called anomalous data packets, in the data stream of the network communication. The rules are subject to tolerances, the ranges of which are defined empirically or in some other way. If the tolerance ranges are too narrow, the case may occur in which anomalies are recognized in the data stream even though anomalies are not present.

U.S. Patent Application Publication No. US 2015/191135 A describes a system in which a decision tree is learned through previous data analysis of a network communication. On the basis of incoming network information, used as input for the decision tree, the learned decision tree is run through using the current network data, and an output is issued indicating whether an anomaly was determined.

U.S. Patent Application Publication No. US 2015/113638 A describes a system that proposes anomaly recognition on the basis of a learning algorithm. Here, data traffic having known meta-information, such as CAN-ID, cycle time, etc., is learned, and in order to recognize known attacks in the vehicle network the current network messages are compared to already-known messages and patterns that indicate the presence of an error or manipulation.

PCT Application No. WO 2014/061021 A1 also describes using a machine learning method to recognize an anomaly or a known attack pattern using various items of network information.

Alternative possibilities for recognizing anomalies in data streams use machine learning methods such as neural networks, autoencoders, and the like. An advantage of the use of machine learning methods for anomaly recognition is that no check rules for data packets have to be manually generated.

In addition, machine learning methods for anomaly recognition also enable recognition of dynamic changes in the network behavior without erroneously classifying these as anomalies. However, up to now it has been difficult to carry out a correct evaluation of dynamic changes of the network behavior, because not every change should result in a recognition of an anomaly. Thus, dynamic changes in the overall system, for example due to particular driving situations such as full braking or travel with increased rotational speed, may affect the network communication of a motor vehicle without its being the case that an anomaly should be recognized.

### SUMMARY

According to the present invention, a method is provided for the automatic recognition of anomalies in a data stream of a communication network, and a corresponding method and a network system are provided.

Example embodiments of the present invention are described herein.

According to a first aspect, an example method for the automatic recognition of anomalies in a data stream in a communication network, is provided in accordance with the present invention, including, e.g., the following steps:

providing a trained variational autoencoder that is trained on non-faulty data packets and/or the features thereof, with specification of a reference distribution of latent quantities indicated by one or more reference distribution parameters;

determining one or more distribution parameters as a function of an input quantity vector that is determined by one or more data packets and is applied to the trained variational autoencoder;

recognition of the one or more data packets as anomalous data packet(s), as a function of the one or more distribution parameters.

The above method uses a variational autoencoder to model a reference distribution of network data in the latent space of the autoencoder. Data packets that cause a deviation from the reference distribution during detection operation of the autoencoder can be recognized as anomalous as a function of the degree of deviation.

The use of the variational autoencoder for such an anomaly recognition method does not require any specification of anomaly detection rules, and can be used simply by specifying a non-faulty data stream for training the variational autoencoder. The use of the above detection method is particularly suitable in the case of data streams that have a cyclical communication of similar data packets, as for example in a serial field bus system such as a CAN or CANFD data bus in vehicles.

In addition, it can be provided that the deviation between the reference distribution indicated by the distribution parameters and the reference distribution indicated by the reference distribution parameters can be carried out using measures of error differing from the Euclidean distance measure, such as a Kullback-Leibler divergence.

In addition, it can be provided that if, on the basis of the one or more distribution parameters, one or more data packets are determined to be non-faulty data packets, then the variational autoencoder is subsequently trained based on the one or more data packets. In this way, the variational autoencoder can be adapted so that the variational autoencoder can be constantly readjusted in accordance with the normal behavior of the communication network.

In addition, the variational autoencoder can be trained with data packets of an anomaly-free data stream, so that on the one hand the reconstruction error between the respective input quantity vector x and the resulting output quantity vector x′ is as low as possible, and on the other hand the distribution of the latent quantities z in the latent space corresponds as closely as possible to the specified reference distribution; here in particular a distribution deviation between the distribution achieved through the one or more distribution parameters and the specified reference distribution should be minimized to the greatest possible extent.

In particular, the distribution deviation that is to be minimized during the training of the variational autoencoder can be ascertained as a measure of a difference between the achieved distribution and the specified reference distribution, the distribution deviation being ascertained in particular as a Kullback-Leibler divergence.

According to a specific embodiment, the data packet can be recognized as an anomalous data packet as a function of the degree of a measure of deviation between the distribution of the latent quantities for the respective applied data packet and the specified reference distribution.

In particular, the degree of deviation can be ascertained as a Kullback-Leibler divergence between the distribution of the latent quantities and the specified reference distribution, or is determined as a measure of a difference between distribution parameters that indicate the distribution that results for the data packet and reference distribution parameters that indicate the reference distribution.

In addition, it can be provided that the degree of deviation is checked using a threshold value comparison in order to recognize a data packet applied as input quantity vector as an anomalous data packet.

The one or more reference distribution parameters that indicate the reference distribution can also be varied as a function of a network state.

In addition, it can be provided that the one or more reference distribution parameters indicating the reference distribution are determined from a plurality of distribution parameters that result from the last-applied data packets, in particular through averaging or weighted averaging, the data packets used for the averaging being specified in particular by their number or by a time segment.

According to a specific embodiment of the present invention, a data packet (P) can be recognized as an anomalous data packet if it is determined, using an outlier recognition method, that the one or more distribution parameters resulting from the relevant data packet (P) differ from the one or more distribution parameters that result from temporally adjacent data packets by more than a prespecified measure.

In addition, the input quantity vector determined from the data packet used can be supplemented with a cluster quantity in order to classify the type of input quantity vector.

According to a specific embodiment of the present invention, the reference distribution can correspond to a distribution that can be parameterized by the one or more distribution parameters, and each latent quantity can be capable of being determined through the distribution parameters, and the reference distribution can correspond to a Gaussian distribution and can be determined for each of the latent quantities through an average value and a variance value.

### BRIEF DESCRIPTION OF THE DRAWINGS

Below, specific embodiments are explained in more detail on the basis of the figures.

FIG. 1 shows a schematic representation of a network system having a communication bus and an anomaly recognition device.

FIG. 2 shows a schematic representation of a variational autoencoder.

FIG. 3 shows an example of a data stream of successive data packets.

FIG. 4 shows a flow diagram illustrating a method for using the variational autoencoder for anomaly recognition in a data stream of a communication network.

### DETAILED DESCRIPTION OF EXAMPLE EMBODIMENTS

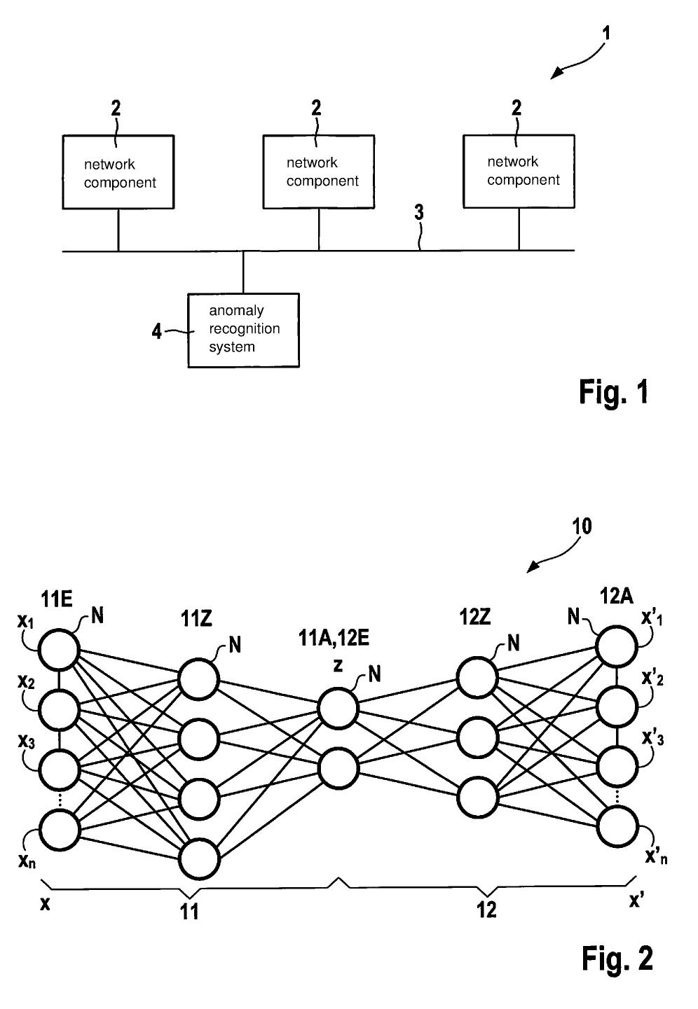

FIG. 1 shows a schematic representation of an overall system 1 having a plurality of network components 2 connected to one another via a communication bus 3. Network components 2 may include control devices, sensors, and actuators. Communication bus 3 can be a field bus or some other data bus, such as a CAN bus (field bus in motor vehicles). Via communication bus 3, a data stream can be transmitted that is made up of a sequence of data packets. Here, a data packet is transmitted from one of the network components 2 to at least one other of the network components 2.

An anomaly recognition system 4, which can be realized separately or as part of one of the network components 2, is connected to communication bus 3. Anomaly recognition system 4 reads the data transmitted via communication bus 3 and carries out an anomaly recognition method based on prespecified rules. Anomaly recognition system 4 may be realized separately or may be part of a network component 2.

A variational autoencoder 10 is the core of the anomaly recognition method described herein, in anomaly recognition system 4. A variational autoencoder is shown as an example in FIG. 2. It has an encoder part 11 and a decoder part 12. Encoder part 11 and decoder part 12 are each realized as neural networks having neurons N. Neurons N each implement a neural function defined for example through the application of an activation function to a sum of a product of weighted inputs with a bias value.

Encoder part 11 maps an input quantity vector x onto a representation z (latent quantities) in a latent space. The latent space has a lower dimensionality than does input quantity vector x. Encoder part 11 has an input layer 11E, one or more intermediate layers 11Z, and an output layer 11A that correspond to, or represent, the latent space. Decoder part 12 maps representation z of the latent space into an output quantity vector x′. The latent space has a lower dimensionality than does output quantity vector x′. In addition to an input layer 12E, which corresponds to or represents the latent space, decoder part 12 can have one or more intermediate layers 12Z and an output layer 12A that has the same dimensionality as input layer 11E of encoder part 11.

In its architecture, variational autoencoder 10 corresponds essentially to a conventional autoencoder; encoder part 11 is probabilistically trained and can thus be designated q_{θ}(z|x), where θ designates the parameters of the neural network. In addition to the above training approach, an a priori distribution of the latent quantities z in the latent space is assumed, and this reference distribution is designated p(z).

During the training of variational autoencoder 10, this autoencoder is trained, for example using a back-propagation method, in such a way that on the one hand the reconstruction error between input quantity vector x and output quantity vector x′ becomes a small as possible. On the other hand, the training is carried out in such a way that the distribution of the latent quantities z in the latent space corresponds as closely as possible to a specified reference distribution. The reference distribution is specified by reference distribution parameters that indicate the reference distribution in a coded manner. The distribution of the latent quantities z is specified by distribution parameters that indicate the distribution in a coded manner. The fact that the distribution of the latent quantities z in the latent space corresponds as closely as possible to a prespecified reference distribution is achieved in a known manner during the training of variational autoencoder 10 by specifying a constraint indicating that a degree of deviation between the achieved distribution and the specified reference distribution is to be made as small as possible.

The resulting distribution parameters represent the trained distribution of the latent quantities z in a correspondingly coded form. The distribution parameters characterize the distribution of the latent quantities z in the latent space. As the reference distribution relative to which the distribution of each of the latent quantities z in the latent space is to have as small a distance measure as possible, for example a Gaussian distribution can be specified by specifying a mean value and a variance. However, other reference distributions are also possible that can be characterized by one or more distribution parameters that are specified in each case.

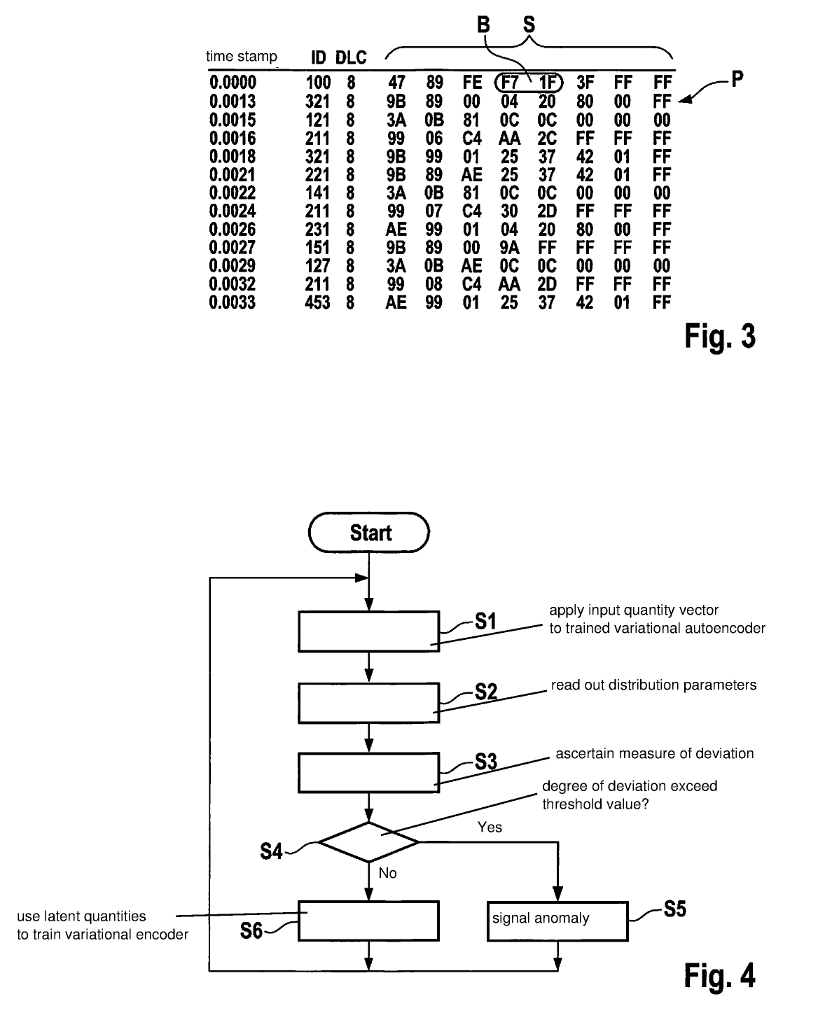

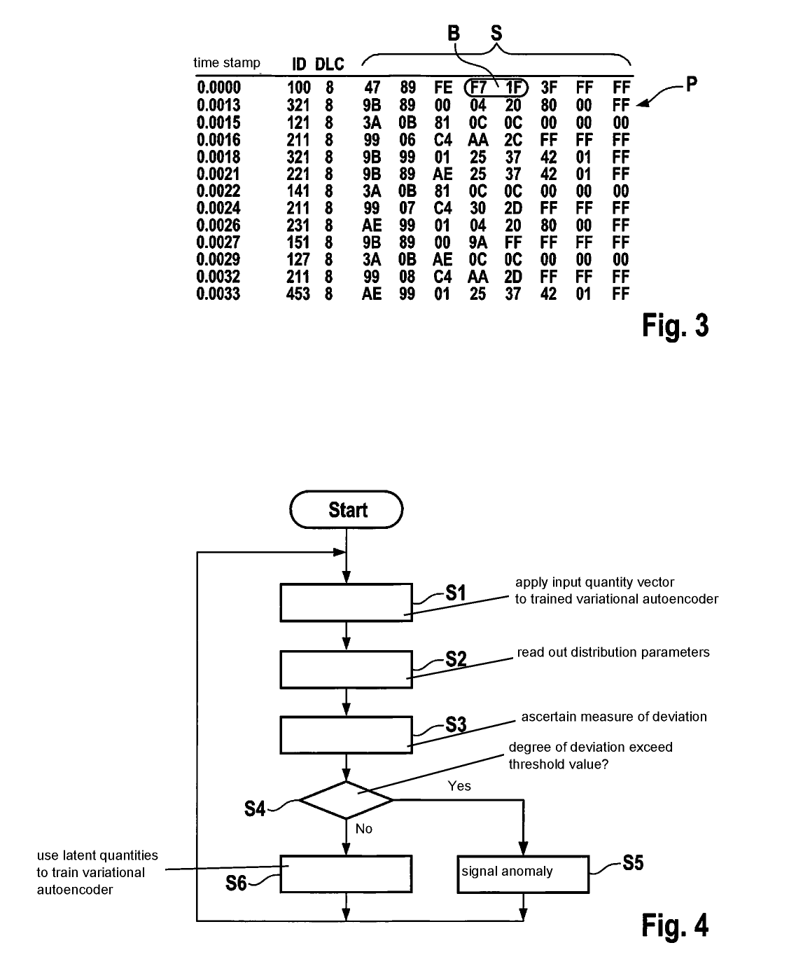

For the variational autoencoder 10 shown in FIG. 2, the next-to-last layer of encoder part 11, i.e. the last intermediate layer 11Z, is a reference distribution layer that contains, in coded fashion, the one or more distribution parameters for each of the latent quantities z in the latent space. As illustrated for example in FIG. 3, the data packets P transmitted via communication bus 3 are defined by, or contain, a timestamp, i.e., the time starting from which the relevant data packet P was sent, the identifier that identifies the source and/or the destination of data packet P, and a data segment S. Data segment S can contain one or more data segments B corresponding to an item of information that is to be transmitted. Data segments B can each contain individual bits, groups of bits, or one or more bytes.

Variational autoencoder 10 is trained with a non-faulty data stream as reference and with the specified reference distribution. During this, the input quantity vectors are generated from the data packets P of the data stream, and can each correspond to one, a plurality of, or a portion of the data packets P, or can be generated from these.

In addition, all, or also only a portion, of the data packets P in the data stream can be used for the training. In particular, only data packets P of the same type, known to have identical or similar types of contents, e.g. data packets having one or more identical identifiers, can be selected for the training. The training can be carried out based on the content of the individually considered data packets, and also as a function of transmission features such as their repetition rate or temporal occurrence within the data stream.

FIG. 4 shows a flow diagram illustrating a method for anomaly recognition in a data stream in a communication network. For this purpose, in step S1 an input quantity vector is applied to the previously trained variational autoencoder 10, the input quantity vector being formed from one or more current data packets or a portion of a data packet.

In step S2, the distribution parameters are read out from encoder part 11. The distribution parameters can correspond to the contents of neurons N of intermediate layer 11Z immediately before output layer 11A, or can be derived from these contents.

In step S3, a measure of deviation is ascertained based on a comparison of the current distribution indicated by the distribution parameters with the reference distribution on which the training is based and that is indicated by the reference distribution parameters. The measure of deviation preferably corresponds to a measure for evaluating a deviation between two distributions, and can be determined in particular as a Kullback-Leibler divergence.

In step S4, the degree of deviation can be checked using a threshold value comparison. If a threshold value is exceeded (alternative: yes), then in step S5 an anomaly is signaled and corresponding measures are carried out. Otherwise (alternative: no), in step S6 the latent quantities z can be used to subsequently train the variational autoencoder based on the non-faulty data packet. In this way, the variational autoencoder can be adapted so that the variational autoencoder can be constantly readjusted corresponding to the normal behavior of the communication network. For the subsequent training of the variational autoencoder, a plurality of non-faulty data packets can also be collected before the new training is carried out. Subsequently, a jump takes place back to step S1.

Through the adaptation of variational autoencoder 10 for further checks, an adaptive matching takes place over time so that the dynamic network behavior can be intercepted and normal changes that occur over time do not cause incorrect recognition of an anomaly (false positive). Step S6 is optional, so that variational autoencoder 10 can also be left unchanged.

Alternatively or in addition, the reference distribution can be varied as a function of a network state. For example, in the case of network states, such as startup, running operation, or shutting down of network components, an appropriate specified reference distribution (in the form of a specification of corresponding reference distribution parameters) can be assumed in each case. For this purpose, variational autoencoder 10 has to be trained for each of the specified reference distributions for each network state.

In addition, in step S4 it can be provided that the distribution parameters on which the comparison is based are determined from a plurality of distribution parameters that result from the last-applied data packets/input quantity vectors, e.g. through averaging, weighted averaging, or the like. The data packets/input quantity vectors used for the averaging can be specified by their number or by a time segment.

When a further data packet/input quantity vector is now transmitted and taken into account, the corresponding distribution parameters are compared to the distribution parameters resulting from the averaging. The deviation of the distribution parameters from the reference distribution parameters can be ascertained using the Kullback-Leibler divergence or some other measure of distance, for example a Euclidean distance. An anomaly can in turn be recognized through a threshold value comparison when a specified deviation between the distribution parameters and the reference distribution parameters is exceeded.

Alternatively, in another specific embodiment, a deviation of the distribution parameters can be determined using an outlier recognition method. Thus, for example the so-called DBSCAN method can be applied to the distribution parameters ascertained for successive relevant input quantity vectors in order to ascertain an outlier in the series of reference parameters. If there is an outlier, then an anomaly is recognized for the data packet that is assigned to the relevant input quantity vector. In the last-described method, the distribution parameters relevant for the outlier recognition method can always be updated to the latest distribution parameters, so that only data packets that lie within a prespecified past time period, or for a specified number of transmitted data packets, are taken into account, in order in this way to enable an adaptive matching over time. In this way, the dynamic network behavior can also be taken into account, so that temporal changes in the network behavior do not necessarily cause a recognition of an anomaly.

Frequently, the distribution of the latent quantities is to a significant extent a function of the type of data packet/input quantity vector. What is concerned here are thus categorical distributions of the individual types of data packets/input quantity vectors that would be difficult to distinguish if one were to model all distributions of all types of data packets/input quantity vectors in the latent space. In order not to have to train a separate variational autoencoder for each individual type of data packet/input quantity vector, an expanded form of the variational autoencoder can be used. For this purpose, a cluster quantity c, classifying the type of data packet/input quantity vector, is added to the input quantity vector x. With this additional information concerning the type of data packet/input quantity vector, the distributions in the latent space can very easily be clustered in the form q(z|X, c).

What is claimed is:

1. A method for the automatic recognition of anomalies in a data stream in a communication network, comprising:
providing a trained variational autoencoder that is trained on non-faulty data packets, with specification of a reference distribution of latent quantities, indicated by reference distribution parameters;
determining one or more distribution parameters as a function of an input quantity vector applied to the trained variational autoencoder, which vector is determined by one or more data packets; and
recognizing the one or more data packets as anomalous data packet(s) as a function of the one or more distribution parameters.

2. The method as recited in claim 1, wherein the variational autoencoder is trained with data packets of an anomaly-free data stream, so that, on the one hand, a reconstruction error between the respective input quantity vector and a resulting output quantity vector becomes a small as possible, and, on the other hand, a distribution of the latent quantities in a latent space corresponds as closely as possible to the specified reference distribution, where a distribution deviation between a distribution determined by the one or more distribution parameters and the reference distribution is minimized to the greatest possible extent.

3. The method as recited in claim 2, wherein the distribution deviation that is minimized during the training of the variational autoencoder is ascertained as a measure of a difference between the determined distribution and the reference distribution, the distribution deviation being ascertained in as a Kullback-Leibler divergence.

4. The method as recited in claim 1, wherein the data packet is recognized as an anomalous data packet as a function of a magnitude of a measure of deviation between the distribution of latent quantities for the respective data packet and the specified reference distribution.

5. The method as recited in claim 4, wherein the measure of deviation being ascertained as a Kullback-Leibler divergence between the distribution of the latent quantities and the specified reference distribution, or being determined as a measure of a difference between distribution parameters that indicate the distribution that results for the data packet and reference distribution parameters that indicate the reference distribution.

6. The method as recited in claim 5, wherein the measure of deviation is checked using a threshold value comparison to recognize the one or more of the data packets represented by the input quantity vector as anomalous data packets.

7. The method as recited in claim 6, wherein, given recognition of one or more data packets as non-faulty data packets, the variational autoencoder is subsequently trained based on the one or more data packets to constantly readjust the variational autoencoder corresponding to a normal behavior of the communication network.

8. The method as recited in claim 6, wherein the one or more reference distribution parameters indicating the reference distribution is varied as a function of a network state.

9. The method as recited in claim 6, wherein the one or more reference distribution parameters indicating the reference distribution is determined from a plurality of distribution parameters that result from last-applied data packets through averaging or weighted averaging, the data packets used for the averaging being specified by their number or by a time segment.

10. The method as recited in claim 1, wherein a data packet is recognized as an anomalous data packet if it is determined, using an outlier recognition method, that the one or more distribution parameters resulting from the data packet differ by more than a prespecified measure from the one or more distribution parameters that result from temporally adjacent data packets.

11. The method as recited in claim 1, wherein the input quantity vector determined from the data packet is supplemented with a cluster quantity to classify a type of the input quantity vector.

12. The method as recited in claim 1, wherein the reference distribution corresponds to a distribution that can be parameterized by the one or more distribution parameters, and each latent quantity being capable of being determined by the distribution parameters, the reference distribution corresponding to a Gaussian distribution, and being determined for each of the latent quantities through a mean value and a variance value.

13. A device for the automatic recognition of anomalies in a data stream in a communication network, the device configured to:
determine one or more distribution parameters as a function of an input quantity vector applied to a trained variational autoencoder, which vector is determined by one or more data packets, the trained variational autoencoder being trained on non-faulty data packets with a specification of a reference distribution of latent quantities indicated by reference distribution parameters; and
recognize the one or more data packets as anomalous data packets as a function of the one or more distribution parameters.

14. A non-transitory electronic storage medium on which is stored a computer program for the automatic recognition of anomalies in a data stream in a communication network, the computer program, when executed by a computer, causing the computer to perform:
providing a trained variational autoencoder that is trained on non-faulty data packets, with specification of a reference distribution of latent quantities, indicated by reference distribution parameters;
determining one or more distribution parameters as a function of an input quantity vector applied to the trained variational autoencoder, which vector is determined by one or more data packets; and
recognizing the one or more data packets as anomalous data packet(s) as a function of the one or more distribution parameters.
